(19) United States
(12) Patent Application Publication
(10) Pub. No.: US 2015/0269345 A1
(43) Pub. Date: Sep. 24, 2015

(54) ENVIRONMENTAL RISK FACTOR RELEVANCY

(71) Applicant: International Business Machines Corporation, Armonk, NY (US)

(72) Inventors: Dhruv A. Bhatt, Indian Trail, NC (US); Kenney Ng, Arlington, MA (US); Gabriel Valencia, San Jose, CA (US)

(73) Assignee: International Business Machines Corporation, Armonk, NY (US)

(21) Appl. No.: 14/219,727

(22) Filed: Mar. 19, 2014

(51) Int. Cl. G06F 19/00

(52) U.S. Cl. CPC G06F 19/3431; G06F 19/322

(57) ABSTRACT

In one example, a method includes processing one or more patient records to generate a history of geographic locations associated with a patient. The method also includes collecting, from one or more data sources, unstructured text containing information describing one or more environments associated with the geographic locations. The method also includes, applying text analytics to the unstructured text to identify one or more environmental risk factors associated with the geographic locations. The method also includes, computing a predictive risk model having, for each of the one or more environmental risk factors, a respective score indicative of a relevancy of the corresponding environmental risk factor to a health condition for the patient. The method also includes, outputting, in accordance with the one or more computed scores of the predictive risk model, information indicative of the relevancy of each of the environmental risk factors to the health condition of the patient.

### BACKGROUND

A person's health may change as a result of exposure to certain environmental risk factors. In some examples, it may be desirable to determine the environmental risk factors to which a particular person has been exposed. For instance, the environmental risk factors may be important when determining the particular person's risk of acquiring certain diseases. However, the particular person may not be aware to which environmental risk factors they have personally been exposed.

In some examples, the information needed to determine which environmental risk factors to which that particular person has been exposed may exist as unstructured text stored at one or more data sources. However, due to the vastness of the data sources, it may not feasible for an individual to access the data sources and determine to which environmental risk factors the particular person has been exposed.

### SUMMARY

In general, examples disclosed herein are directed to techniques for determining the relevancy of one or more environmental risk factors to a patient based on the patient's location history.

In one example, a method includes processing, with a computing device, one or more patient records to generate a history of geographic locations associated with a patient. In this example, the method also includes collecting, with a computing device and from one or more data sources, unstructured text containing information describing one or more environments associated with the geographic locations. In this example, the method also includes, applying, with the computing device, text analytics to the unstructured text to identify one or more environmental risk factors associated with the geographic locations. In this example, the method also includes computing, with the computing device, a predictive risk model having, for each of the environmental risk factors, a respective score indicative of a relevancy of the corresponding environmental risk factor to a health condition for the patient. In this example, the method also includes outputting, in accordance with the one or more computed scores of the predictive risk model, information indicative of the relevancy of each of the environmental risk factors to the health condition of the patient.

In another example, a system includes a memory, one or more processors, and at least one module executable by the one or more processors. In this example, the at least one module is executable by the one or more processors to process one or more patient records to generate a history of geographic locations associated with a patient. In this example, the at least one module is also executable by the one or more processors to collect, from one or more data sources, unstructured text containing information describing one or more environments associated with the geographic locations. In this example, the at least one module is also executable by the one or more processors to apply text analytics to the unstructured text to identify one or more environmental risk factors associated with the geographic locations. In this example, the at least one module is also executable by the one or more processors to compute a predictive risk model having, for each of the one or more environmental risk factors, a respective score indicative of a relevancy of the corresponding environmental risk factor to a health condition for the patient. In this example, the at least one module is also executable by the one or more processors to output, in accordance with the one or more computed scores of the predictive risk model, information indicative of the relevancy of each of the environmental risk factors to the health condition of the patient.

In another example, a computer-readable storage medium stores instructions that, when executed, cause one or more processors of a computing system to process one or more patient records to generate a history of geographic locations associated with a patient. In this example, the computer-readable storage medium also stores instructions that, when executed, cause the one or more processors to collect, from one or more data sources, unstructured text containing information describing one or more environments associated with the geographic locations. In this example, the computer-readable storage medium also stores instructions that, when executed, cause the one or more processors to apply text analytics to the unstructured text to identify one or more environmental risk factors associated with the geographic locations. In this example, the computer-readable storage medium also stores instructions that, when executed, cause the one or more processors to compute a predictive risk model having, for each of the one or more environmental risk factors, a respective score indicative of a relevancy of the corresponding environmental risk factor to a health condition for the patient. In this example, the computer-readable storage medium also stores instructions that, when executed, cause the one or more processors to output, in accordance with the one or more computed scores of the predictive risk model, information indicative of the relevancy of each of the environmental risk factors to the health condition of the patient.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system that is configured to determine the relevancy of one or more environmental risk factors to a patient based on the patient's location history, in accordance with one or more techniques of the present disclosure.

FIG. 2 depicts a flow diagram of example operation of a system that is configured to determine the relevancy of one or more environmental risk factors to a patient based on the patient's location history, in accordance with one or more techniques of the present disclosure.

FIG. 3 is a block diagram of a computing device that may be used to determine the relevancy of one or more environmental risk factors to a patient based on the patient's location history, in accordance with one or more techniques of the present disclosure.

### DETAILED DESCRIPTION

Various examples are disclosed herein for determining the relevancy of one or more environmental risk factors to a patient based on the patient's location history. In some examples, a computing device may analyze unstructured text to identify the one or more environmental risk factors associated with one or more geographical locations included in the patient's location history. For each of the identified environmental risk factors, the computing device may determine a respective score indicative of a relevancy of the corresponding environmental risk factor to a health condition for the patient. Based on the determined score(s), the computing device may output information indicative of the relevancy of the environmental risk factors to the health condition of the patient.

As one example, a patient's location history may indicate that the patient lived in Fukushima, Japan. A computing device may analyze unstructured text from a news article to identify radiation as an environmental risk factor associated with Fukushima, Japan. The computing device may compute a score indicative of a relevancy of radiation to a health condition for the patient. The computing device may output information that indicates whether or not the potential exposure to radiation is relevant to the health condition of the patient.

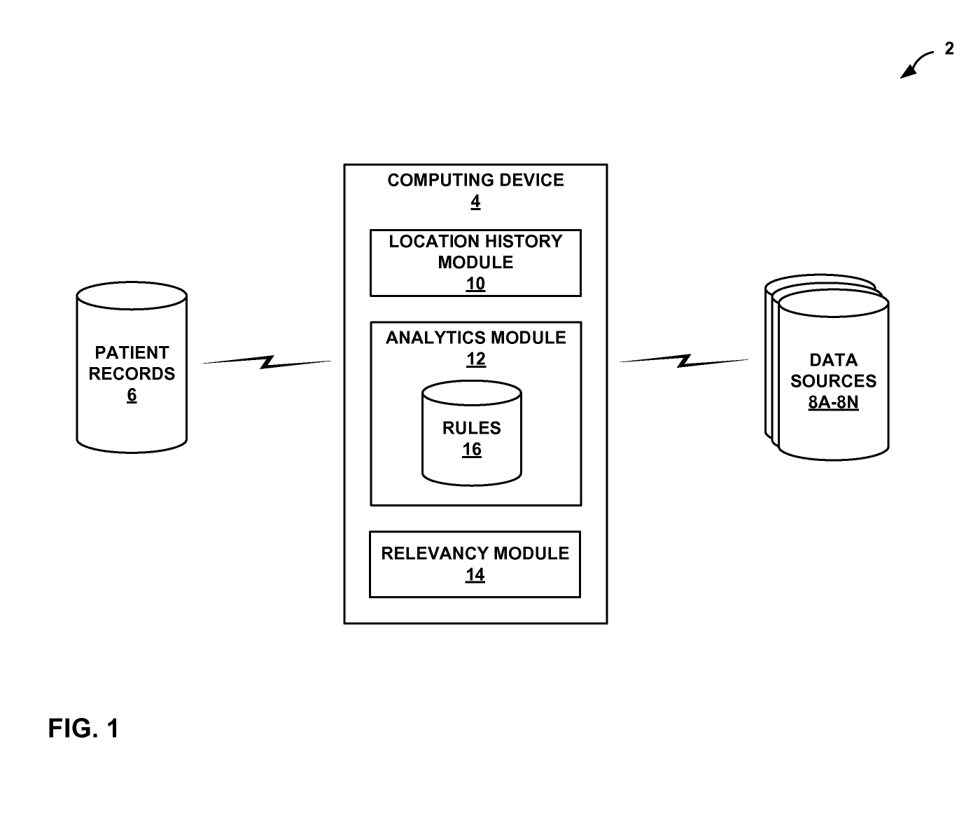

FIG. 1 is a block diagram illustrating example system 2 that is configured to determine the relevancy of one or more environmental risk factors to a patient based on the patient's location history, in accordance with one or more techniques of the present disclosure. As illustrated in FIG. 1, system 2 may include computing device 4, patient records 6, and data sources 8A-8N (collectively, “data sources 8”).

In some examples, computing device 4 may be configured to determine the relevancy of one or more environmental risk factors to a patient based on the patient's location history. Examples of computing device 4 may include, but are not limited to, desktop computers, laptop computers, mainframes, servers, cloud computing systems, and/or combinations of the same. In some examples, computing device 4 may be integrated into a hospital's computing system. As illustrated in FIG. 1, computing device 4 may include location history module 10, analytics module 12, and relevancy module 14.

In some examples, location history module 10 may be configured to determine a location history for a patient. In some examples, location history module 10 may determine the location history for the patient by generating a history of prior geographic locations for the patient. Location history module 10 may output the determined location history to one or more other components of computing device 4, such as analytics module 12 and/or relevancy module 14.

Analytics module 12 may be configured to analyze unstructured text received from one or more data sources to identify one or more environmental risk factors associated with one or more geographical locations. For instance, analytics module 12 may analyze unstructured text received from one or more of data sources 8 to identify one or more environmental risk factors associated with one or more geographic locations included in the patient's location history received from location history module 10. In some examples, analytics module 12 may apply one or more annotators and/or one or more phrase dictionaries included rules database 16 to the unstructured text to identify one or more environmental risk factors associated with one or more geographical locations. Analytics module 12 may output the identified one or more environmental risk factors to one or more other components of computing device 4, such as relevancy module 14.

In some examples, analytics module 12 may include rules database 16 which may be configured to store one or more annotators and/or one or more phrase dictionaries. For instance, rules database 16 may store one or more annotators and/or one or more phrase dictionaries that associate unstructured text with one or more environmental risk factors.

Relevancy module 14 may be configured to determine, for each of one or more environmental risk factors, a respective score indicative of a relevancy of the corresponding environmental risk factor to a health condition for a patient. For instance, relevancy module 14 may determine, for each of the environmental risk factors identified by analytics module 12, a respective score indicative of a relevancy of the corresponding environmental risk factor to a health condition for a patient. The scores determined by relevancy module 14 may indicate how relevant the particular factor is to a particular patient based on the patient's medical record and environment information. In some examples, the environmental risk factors and their associated relevancy scores may serve as input to predictive models that may generate risk scores for medical issues based on environmental factors. Additionally, in some examples, the factors may be examined on their own to give investigators possible insight into new risk models based on factors that may not have been previously known.

In some examples, system 2 may include patient records 6, which may be configured to store records corresponding to a plurality of patients. For instance, patient records 6 may store medical records (e.g., previous health conditions, current symptoms, test results, etc.), billing records, and the like. In some examples, patient records 6 may be included in computing device 4. For instance, in example where computing device 4 is included in a hospital computing environment, patient records 6 may be stored in one or more storage devices included in the hospital computing environment.

In some examples, system 2 may include data sources 8, which may be configured to store unstructured text in a wide variety of formats. Examples of data sources 8 may include, but are not limited to, tweets, blogs, social network posts, forums, and news articles. In some examples, unstructured text may include information that does not have a pre-defined data model and/or information that is not organized in a pre-defined manner. In some examples, unstructured text may include semi-structures text, such as XML tagged text. In some examples, one or more of data sources 8 may be designated as trusted data sources. For instance, a user of computing device 4 may designate one or more of data sources 8 as a trusted data source. In some examples, one or more of data sources 8 may be operatively connected to computing device 4 via the Internet, a local area network (LAN), a storage area network (SAN), or any other data connection.

In accordance with one or more aspects of the present disclosure, computing device 4 may determine the relevancy of one or more environmental risk factors to a health condition for a patient based on the patient's location history.

Location history module 10 may determine the patient's location history. As one example, location history module 10 may process one or more patient records received from patient records 6 to generate a history of prior geographical locations for the patient. For instance, location history module 10 may analyze prior billing addresses for the patient included in patient records 6 to determine one or more geographical locations for the patient. As another example, location history module 10 may receive user input that indicates one or more geographical locations for the patient. For instance, a medical professional (e.g., a doctor, nurse) may receive information that indicates one or more geographical locations for the patient while interviewing the patient and provide user input to computing device 4 indicating the same. As yet another example, location history module 10 may analyze one or more social network accounts associated with the patient to determine one or more geographical locations for the patient. For instance, location history module 10 may determine that the patient was at a particular geographical location where the patient is tagged or otherwise identified in a photograph or post associated with the particular geographical location.

In some examples, location history module 10 may determine a respective time or time period for one or more of the geographical locations included in the patient's location history that indicates when the patient was at the respective geographical location. For instance, location history module 10 may determine that the patient was at a particular geographical location, such as Fukushima, Japan, from May 8, 2008 until Dec. 21, 2013. In any case, location history module 10 may provide the determined location history for the patient to analytics module 12.

Analytics module 12 may analyze unstructured text received from one or more data sources to identify one or more environmental risk factors associated with one or more geographical locations. For instance, analytics module 12 may analyze unstructured text received from one or more of data sources 8 to identify one or more environmental risk factors associated with one or more geographic locations included in the patient's location history received from location history module 10. As one example, analytics module 12 may collect, from one or more of data sources 8, unstructured text containing information describing environments associated with the geographic locations included in the location history received from location history module 10. For instance, analytics module 12 may collect, from one or more of data sources 8, news articles containing unstructured text information describing environments associated with Fukushima, Japan. In some examples, analytics module 12 may be configured to only collect unstructured text from a subset of data sources 8 that are identified as trusted data sources.

Analytics module 12 may apply text analytics to the unstructured text to identify one or more environmental risk factors associated with the geographical locations. As one example, analytics module 12 may apply a parsing engine to parse structured content from the unstructured text and apply a phrase dictionary to the structured content to identify the environmental risk factors. In some examples, analytics module 12 includes an unstructured information management architecture (UIMA) configured to analyze the unstructured text to identify the one or more environmental risk factors associated with the geographical location. In some examples, analytics module 12 may apply one or more annotators (each annotator including one or more dictionaries and parsing rules databases) to the unstructured text to identify the one or more environmental risk factors associated with the geographical location. For instance, analytics module 12 may apply one or more annotators to the news articles containing unstructured text information describing environments associated with Fukushima, Japan to identify radiation as an environmental risk factor associated with Fukushima, Japan.

In some examples, analytics module 12 may determine whether or not a database includes one or more predetermined environmental risk factors associated with a particular geographical location of the past geographic locations for the patient. The one or more predetermined environmental risk factors associated with the particular geographical location may have been previously identified by analytics module 12. For instance, as analytics module 12 operates over time, analytics module 12 may build a database of environmental risk factors identified for a plurality of geographic locations. As one example, analytics module 12 may have previously identified radiation as an environmental risk factor associated with Fukushima, Japan.

In some examples, responsive to determining that the database does not include the one or more predetermined environmental risk factors associated with the geographical location, analytics module 12 may apply the text analytics to the unstructured text, as discussed above, to identify the one or more environmental risk factors associated with the geographic location. In some examples, responsive to determining that the database does include the one or more predetermined environmental risk factors associated with the geographical location, analytics module 12 may receive, from the database, the predetermined environmental risk factors associated with the geographical location. In any case, analytics module 12 may output the identified one or more environmental risk factors associated with the geographical locations to relevancy module 14.

Relevancy module 14 may determine, for at least one of the one or more environmental risk factors received from analytics module 12, a respective score indicative of a relevancy of the corresponding environmental risk factor to a health condition for the patient. As one example, relevancy module 14 may compute a predictive risk model having, for at least one of the environmental risk factors, a respective score indicative of a relevancy of the corresponding environmental risk factor to a health condition for the patient. For instance, relevancy module 14 may determine that exposure to radiation has a high relevancy score for one or more health conditions for the patient, such as cancer. In other words, the predictive risk model determined by relevancy module 14 may indicate that the patient has a high probability of contracting cancer/being admitted to the hospital for cancer. Additionally, relevancy module 14 may determine that exposure to radiation has a low relevancy score for one or more other health conditions for the patient, such as broken bones.

In some examples, relevancy module 14 may determine the relevancy score based on one or more additional factors that are taken into account when determining the relevancy score. For example, analytics module 12 may identify contaminated public drinking water as an environmental risk factor at one or more of the geographical locations included in the patient's location history. However, information (such as information stored in patient records 6) may indicate that the patient rarely if ever drinks public water, choosing instead to drink from bottled water. Based on this additional information, relevancy module 14 may determine a lower relevancy score for the patient compared to another patient that always drinks tap water.

Relevancy module 14 may output, in accordance with the determined scores, information indicative of the relevancy of the environmental risk factors to the health condition of the patient. As one example, relevancy module 14 may output information indicating a probability that the patient will experience the health condition (e.g., where the health condition is a disease, the probability of disease onset). As another example, relevancy module 14 may output information indicating a probability that the patient will be admitted (or re-admitted) to the hospital. As another example, relevancy module 14 may output information indicating a treatment plan for the patient. For instance, relevancy module 14 may output a probability that the patient will respond to a drug/treatment.

For exemplary purposes, various examples of the techniques of this disclosure may be readily applied to various software systems, including large-scale enterprise computing and software systems, and including computing systems with intensive demands for large amounts of data with high availability for processing. Examples of enterprise software systems include enterprise hospital systems, enterprise financial or budget planning systems, order management systems, inventory management systems, sales force management systems, business intelligence tools, enterprise reporting tools, project and resource management systems, and other enterprise software systems.

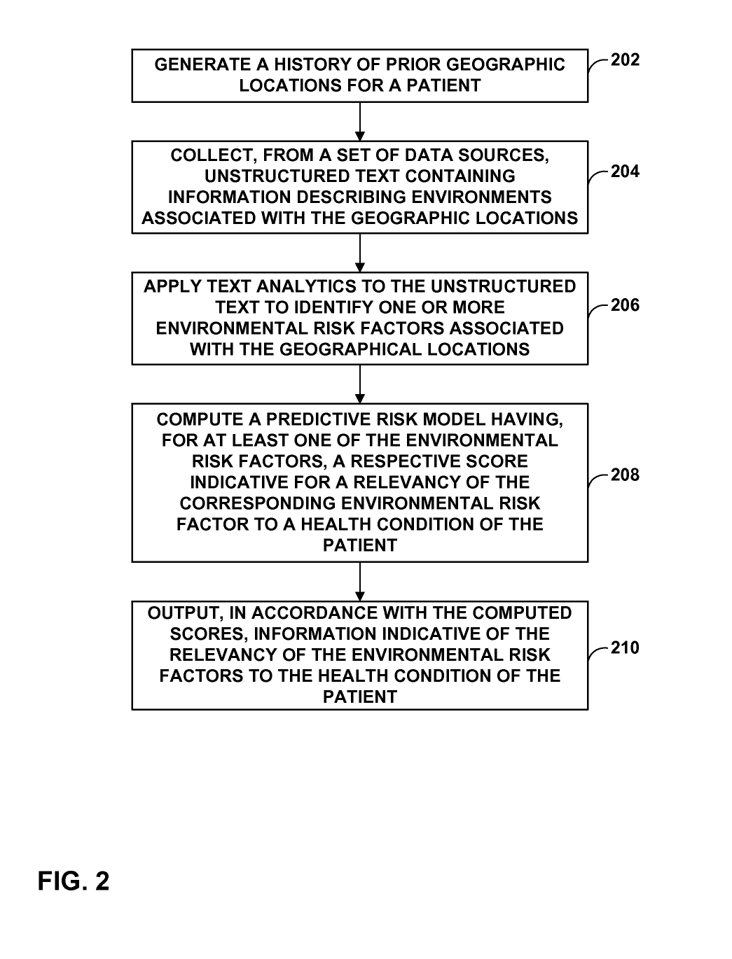

FIG. 2 is a flow diagram illustrating example operations of a computing device that determines the relevancy of one or more environmental risk factors to a patient based on the patient's location history, in accordance with one or more techniques of the present disclosure. The techniques of FIG. 2 may be performed by one or more processors of a computing device, such as computing device 4 illustrated in FIG. 1. For purposes of illustration, the techniques of FIG. 2 are described within the context of computing device 4 of FIG. 1, although computing devices having configurations different than that of computing device 4 may perform the techniques of FIG. 2.

In accordance with one or more techniques of this disclosure, location history module 10 of computing device 4 may generate a history of prior geographic locations for a patient (202). As discussed above, in some examples, location history module 10 may generate the history of prior geographical locations for the patient based on one or more of patient records (e.g., patient records 6), information received from the patient and provided to computing device 4, and/or information derived from a social network account associated with the patient.

Analytics module 12 may collect, from a set of data sources (e.g., one or more of data sources 8), unstructured text containing information describing environments associated with the geographical locations (204). As discussed above, in some examples, a subset of data sources 8 may be designated as trusted data sources. In such examples, analytics module 12 may only collect unstructured text from the trusted data sources.

Analytics module 12 may apply text analytics to the unstructured text to identify one or more environmental risk factors associated with the geographical locations (206). As discussed above, in some examples, analytics module 12 may apply one or more annotators to the unstructured text to determine the one or more environmental risk factors associated with the geographical location.

Relevancy module 14 may compute a predictive risk model having, for at least one of the environmental risk factors, a respective score indicative for a relevancy of the corresponding environmental risk factor to a health condition of the patient (208). As discussed above, in some examples, relevancy module 14 may determine the relevancy score based on one or more additional factors.

Relevancy module 14 may output, in accordance with the computed scores, information indicative of the relevancy of the environmental risk factors to the health condition of the patient (210). As discussed above, relevancy module 14 may output information indicating, for example, a probability that the patient will experience the health condition (e.g., where the health condition is a disease, the probability of disease onset), a probability that the patient will be admitted (or re-admitted) to the hospital, and/or a probability that the patient will respond to a drug/treatment.

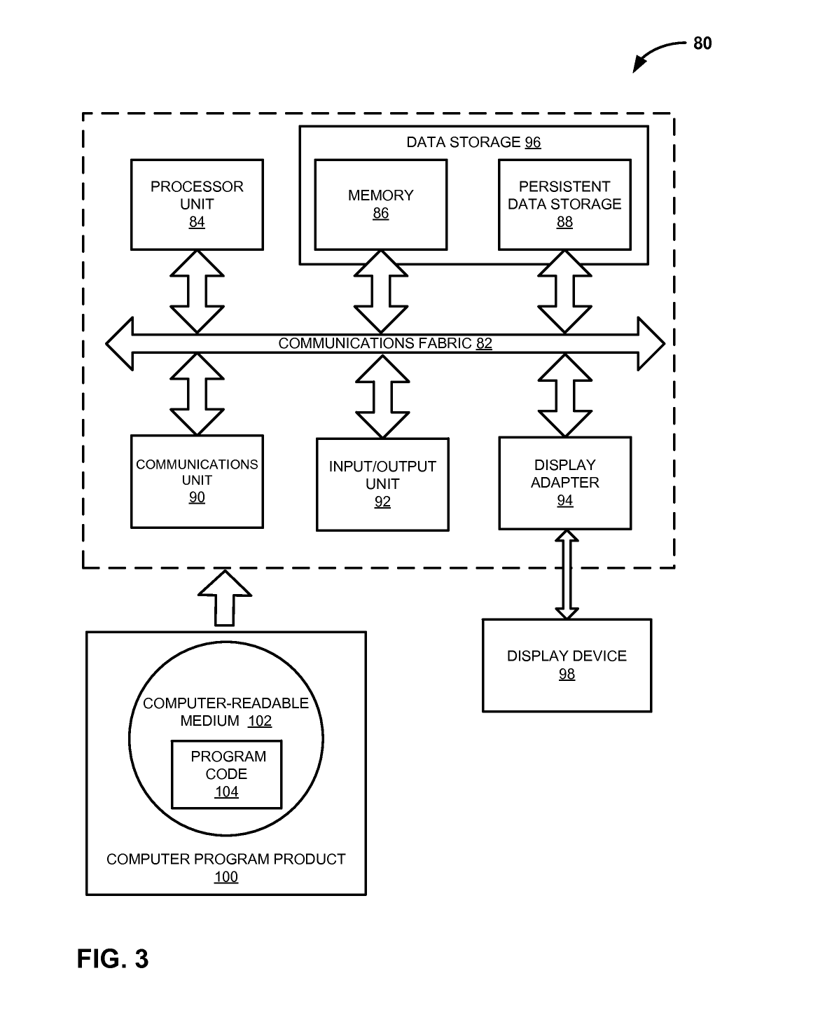

FIG. 3 is a block diagram of a computing device 80 that may be used to determine the relevancy of one or more environmental risk factors to a patient based on the patient's location history, in accordance with an example of this disclosure. Computing device 80 may be an example of computing device 4 as depicted in FIG. 1. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind Other implementations of a computing device 80 may include a computer having capabilities or formats other than or beyond those described herein.

In the illustrative example of FIG. 3, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a cache sync manager 22, as described in greater detail above. This program code may be stored on memory 86, persistent data storage 88, or elsewhere in computing device 80. This program code may also take the form of program code 104 stored on computer-readable medium 102 (e.g., a computer-readable storage medium) comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of computer-readable medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

1-7. (canceled)

8. A system comprising:
a memory;
one or more processors; and
at least one module executable by the one or more processors to:
process one or more patient records to generate a history geographic locations associated with a patient;
collect, from one or more data sources, unstructured text containing information describing one or more environments associated with the geographic locations;
apply text analytics to the unstructured text to identify one or more environmental risk factors associated with the geographic locations;
compute a predictive risk model having, for each of the one or more environmental risk factors, a respective score indicative of a relevancy of the corresponding environmental risk factor to a health condition for the patient; and
output, in accordance with the one or more computed scores of the predictive risk model, information indicative of the relevancy of each of the environmental risk factors to the health condition of the patient.

9. The system of claim 8, wherein the at least one module is configured to apply text analytics by at least:
applying a parsing engine to parse structured content from the unstructured text; and
applying a phrase dictionary to the structured content to identify the one or more environmental risk factors.

10. The system of claim 8, wherein the at least one module is configured to apply text analytics by at least:
applying one or more annotators to the unstructured text to identify the one or more environmental risk factors.

11. The system of claim 8, wherein the at least one module is configured to collect, from the set of data sources, unstructured text by at least:
collecting, from one or more trusted data sources, the unstructured text.

12. The system of claim 8, wherein the one or more patient records indicate an address history of the patient.

13. The system of claim 8, wherein the at least one module is further executable by the one or more processors to:
process one or more social network accounts corresponding to the patient to generate the history of the geographic locations associated with the patient.

14. The system of claim 8, wherein the at least one module is further executable by the one or more processors to:
determine whether or not a database includes one or more predetermined environmental risk factors associated with a particular geographical location of the geographic locations associated with the patient;
responsive to determining that the database does not include the one or more predetermined environmental risk factors associated with the particular geographical location, apply text analytics to the unstructured text to identify the one or more environmental risk factors associated with the geographic location; and
responsive to determining that the database does include the one or more predetermined environmental risk factors associated with the particular geographical location:
receive, from the database, the predetermined environmental risk factors associated with the particular geographical location; and
use the predetermined environmental risk factors to compute the predictive risk model.

15. A computer-readable storage medium storing instructions that, when executed, cause one or more processors of a computing system to:
process one or more patient records to generate a history of geographic locations associated with a patient;
collect, from one or more data sources, unstructured text containing information describing one or more environments associated with the geographic locations;
apply text analytics to the unstructured text to identify one or more environmental risk factors associated with the geographic locations;
compute a predictive risk model having, for each of the one or more environmental risk factors, a respective score indicative of a relevancy of the corresponding environmental risk factor to a health condition for the patient; and
output, in accordance with the one or more computed scores of the predictive risk model, information indicative of the relevancy of each of the environmental risk factors to the health condition of the patient.

16. The computer-readable storage medium of claim 15, wherein the instructions that cause the one or more processors to apply text analytics comprise instructions that cause the one or more processors to:
apply a parsing engine to parse structured content from the unstructured text; and
apply a phrase dictionary to the structured content to identify the one or more environmental risk factors.

17. The computer-readable storage medium of claim 15, wherein the instructions that cause the one or more processors to apply text analytics comprise instructions that cause the one or more processors to:
apply one or more annotators to the unstructured text to identify the one or more environmental risk factors.

18. The computer-readable storage medium of claim 15, wherein the instructions that cause the one or more processors to collect, from the set of data sources, unstructured text comprise instructions that cause the one or more processors to:
collect, from one or more trusted data sources, the unstructured text.

19. The computer-readable storage medium of claim 15, further storing instructions that cause the one or more processors to:
process one or more social network accounts corresponding to the patient to generate the history of the geographic locations associated with the patient.

20. The computer-readable storage medium of claim 15, further storing instructions that cause the one or more processors to:
determine whether or not a database includes one or more predetermined environmental risk factors associated with a particular geographical location of the past geographic locations associated with the patient;
responsive to determining that the database does not include the one or more predetermined environmental risk factors associated with the particular geographical location, apply text analytics to the unstructured text to identify the one or more environmental risk factors associated with the geographic location; and
responsive to determining that the database does include the one or more predetermined environmental risk factors associated with the geographical location:
receive, from the database, the predetermined environmental risk factors associated with the particular geographical location; and
use the predetermined environmental risk factors to compute the predictive risk model.
